(19) United States
(12) Patent Application Publication
(10) Pub. No.: US 2008/0053552 A1
(43) Pub. Date: Mar. 6, 2008

(54) Wireless rubber vacuum hose

(76) Inventor: Jeffrey R. Shope, Westerville, OH (US)

Correspondence Address: BUTZER & CHEN LAW, LLC, 870 HIGH STREET, SUITE 104, WORTHINGTON, OH, 43085, US

(21) Appl. No.: 11/514,522

(22) Filed: Sep. 1, 2006

(51) Int. Cl. F16L 11/00

(52) U.S. Cl. 138/137; 138/109; 138/121

(57) ABSTRACT

A rubber vacuum hose, including a rubber middle section that includes an inner layer and an outer layer, but that lacks a support wire. The rubber middle section preferably is able to withstand temperatures of at least two hundred degrees Fahrenheit. The hose also includes two ends attached to either side of the middle section. At least one of the two ends is capable of adapting removably to a vacuum cleaning tool. Preferably, the rubber middle section is flexible enough to be tied into a knot without damage. In a preferred embodiment, the middle section is composed of ethylene propylene, ethylene propylene diene methylene terpolymer, or a mixture thereof suitable to withstand high negative pressure.

### FIELD OF INVENTION

The present invention relates generally to a wireless rubber vacuum hose for industrial uses.

### BACKGROUND OF THE INVENTION

Vacuums, especially industrial strength vacuums, generate high negative pressure. In order for a conventional industrial strength vacuum hose to handle this high negative pressure, the hose requires a support wire to be encapsulated between two layers of rubber material. Such a vacuum hose can be bulky, relatively inflexible, and hard to use. Making a hose with a support wire between two layers of rubber material can be complicated and expensive. Moreover, since separating the support wire from two-layer rubber material can be difficult, recycling may be expensive as well.

Ethylene propylene (EP) and ethylene propylene diene methylene terpolymer (EPDM) rubbers are recognized for their resistance to weathering and extreme temperatures. Often these rubbers are used extensively in outdoor applications. However, Applicant is not aware of any attempts to use EP/EPDM rubbers under the stressful conditions to which industrial strength vacuum hoses are often subjected, such as high negative pressure and extreme temperature.

### SUMMARY OF INVENTION

In view of the foregoing, considerable demand exists for a flexible vacuum hose without a bulky support wire that still maintains the ability to withstand high negative pressure and extreme temperatures.

Embodiments of the invention address some or all of the concerns discussed above. One embodiment of the invention relates to a rubber vacuum hose including a rubber middle section that includes an inner layer and an outer layer, but that lacks a support wire. The rubber middle section preferably is able to withstand temperatures of at least two hundred degrees Fahrenheit. The hose also includes two ends attached to either side of the middle section. At least one of the two ends is capable of adapting removably to a vacuum cleaning tool.

Preferably, the rubber middle section is flexible enough to be tied into a knot without damage. In a preferred embodiment, the middle section is composed of ethylene propylene, ethylene propylene diene methylene terpolymer, or a mixture thereof (i.e., EP/EPDM). These materials provide suitable strength for withstanding high negative pressure, good flexibility, and resistance to extreme temperatures even without a middle layer of support wire.

In a further embodiment of a wireless rubber vacuum hose, both ends of the hose are capable of adapting removably to a vacuum cleaning tool.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF DRAWING

FIG. 1 shows a top view of an embodiment of a wireless negative pressure rubber vacuum hose.

FIG. 2 shows a sectional view of the wireless negative pressure rubber vacuum hose in FIG. 1.

FIG. 3 is a flowchart of a method of making an embodiment of a wireless negative pressure rubber vacuum hose.

### DETAILED DESCRIPTION OF THE PREFERRED EMBODIMENTS

Briefly, one embodiment of the invention relates to a rubber vacuum hose including a rubber middle section that includes of an inner layer and an outer layer, but that lacks a support wire. The rubber middle section preferably is able to withstand temperatures of at least two hundred degrees Fahrenheit. The hose also includes two ends attached to either side of the middle section. At least one of the two ends is capable of adapting removably to a vacuum cleaning tool, for example for vacuuming debris.

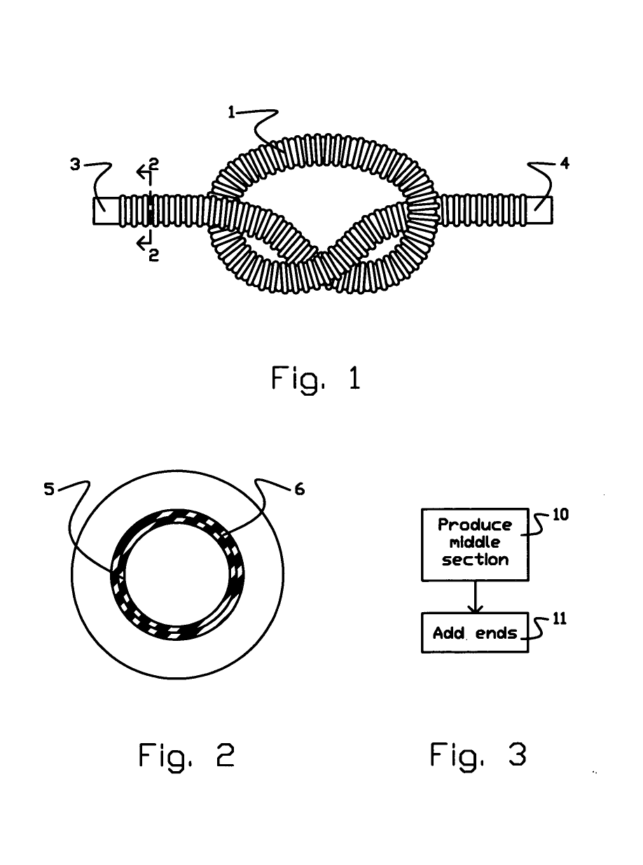

Thus, a rubber vacuum hose in FIG. 1 includes rubber middle section 1 with two ends 3 and 4 attached to either side of the middle section. Middle section 1 preferably is formed in an accordion-like configuration so that it can stretch and contract as needed. In one embodiment, the hose is five feet long and can stretch to twelve feet long. This embodiment is particularly suited for, but not limited to, more industrial applications. In another embodiment, the host is two and a half feet long and can stretch to six feet. This embodiment is particularly suited for, but not limited to, more home or small business (e.g., car detailing and home remodeling) applications.

At least one of the two ends 3 and 4 is capable of adapting removably to a vacuum cleaning tool. Examples of such a cleaning tool include, but are not limited to, a ShopVac®, industrial ShopVac®, or similar vacuum device. Many ShopVacs® and the like have a connector that accepts a 2½″ diameter end, so the end could be 2½″ in diameter. Many other ShopVacs® and the like have a connector or adapter that accepts a 1½″ diameter end, so the end also could be this size. Other sizes can be used for the ends to accommodate other vacuum connectors and adapters.

The other end of the rubber vacuum hose preferably is capable of adapting to nozzles such as angled nozzles, brush nozzles, and the like. Alternatively, both ends could be the same, that is both capable of adapting removably to a vacuum cleaning tool, and the nozzles could be configured to fit those ends. Furthermore, use of a nozzle is not required.

In some embodiments, one or both of ends 3 and 4 include rotating cuffs. Alternatively, no rotating cuffs could be used.

Preferably, the middle section of the rubber vacuum hose does not contain any support wire. This is shown in FIG. 2, which is a sectional view along line 2-2 in FIG. 1. FIG. 2 shows middle section 1 with inner layer 5 and outer layer 6, but no support wire between the layers. One result of this construction is that a preferred embodiment of the hose can be tied into a knot as shown in FIG. 1 without damage. In contrast, hoses with support wires tend to be damaged if bent in such a fashion. Namely, the support wire tends to become bent or deformed.

A preferred embodiment of the middle section of the rubber vacuum hose is composed of ethylene propylene (EP), ethylene propylene diene methylene terpolymer (EPDM), or a mixture thereof (EP/EPDM) suitable to withstand high negative pressure (i.e., suction such as produced by a ShopVac® or the like) and extreme temperature. EP and EPDM are two types of EP rubber available on the market today. Ethylene propylene (EP) rubber uses a peroxide cure system while ethylene propylene diene methylene terpolymer (EPDM) rubber uses a sulfur cure system.

One embodiment of the rubber vacuum hose uses EP/EPDM rubber with a density of 0.86 g/cm³, a maximum use temperature of 400° F., a minimum continuous use temperature of −75° F., a thermal conductivity of 0.15 btu/hr/sq.ft/° F./ft, a cubical coefficient of expansion of 26-32 in/in/° F.×10⁻⁶, a tensile strength of 0.3-3.4×10³ psi, a hardness durometer of 30 A-90 A, a hardness shore of 120-390, and a vacuum weight loss of 0.39%-0.93% after 14 days at 1×10⁻⁶ torr. Other types of EP, EPDM, EP/EPDM, and rubbers can be used instead.

FIG. 3 is a flowchart of a method of making an embodiment of a wireless negative pressure rubber vacuum hose. In step 10, a rubber middle section as described above is produced. In step 11, two ends as described above are attached to either side of the middle section.

### Alternative Embodiments

The invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. The terms “comprising” or “including” mean that other elements and/or steps can be added without departing from the invention. Many other variations are possible which remain within the content, scope and spirit of the invention, and these variations would become clear to those skilled in the art after perusal of this application.

1. A wireless rubber vacuum hose, including:
a rubber middle section that includes an inner layer and an outer layer, wherein the middle section lacks a support wire and is able to withstand high negative pressure and temperatures of at least two hundred degrees Fahrenheit:
two ends attached to either side of the middle section, wherein at least one of the two ends is capable of adapting removably to a vacuum cleaning tool; and
wherein said middle section is composed of ethylene propylene, ethylene propylene diene methylene terpolymer, or a mixture thereof.

2. A wireless rubber vacuum hose as in claim 1, wherein the rubber middle section is flexible enough to be tied into a knot without damage.

3. (canceled)

4. A wireless rubber vacuum hose as in claim 1, wherein the ethylene propylene, ethylene propylene diene methylene terpolymer, or mixture thereof has a density of 0.86 g/cm³, a maximum use temperature of 400° F., a minimum continuous use temperature of −75° F., a thermal conductivity of 0.15 btu/hr/sq.ft/° F./ft, a cubical coefficient of expansion of 26-32 in/in/° F.×10⁻⁶, a tensile strength of 0.3-3.4×10³ psi, a hardness durometer of 30 A-90 A, a hardness shore of 120-390, and a vacuum weight loss of 0.39%-0.93% after 14 days at 1×10⁻⁶ torr.

5. A wireless rubber vacuum hose as in claim 1, wherein both ends of the hose are capable of adapting removably to a vacuum cleaning tool for vacuuming debris.

6. A method of making a wireless rubber vacuum hose, including:
producing a rubber middle section that includes of an inner layer and an outer layer, wherein the middle section lacks a support wire and is able to withstand temperatures of at least two hundred degrees Fahrenheit;
attaching two ends to either side of the middle section, wherein at least one of the two ends is capable of adapting removably to a vacuum cleaning tool; and
wherein said middle section is composed of ethylene propylene, ethylene propylene diene methylene terpolymer, or a mixture thereof.

7. A method as in claim 6, wherein the rubber middle section is flexible enough to be tied into a knot without damage.

8. (canceled)

9. A method as in claim 6, wherein the ethylene propylene, ethylene propylene diene methylene terpolymer, or mixture thereof has a density of 0.86 g/cm³, a maximum use temperature of 400° F., a minimum continuous use temperature of −75° F., a thermal conductivity of 0.15 btu/hr/sq.ft/° F./ft, a cubical coefficient of expansion of 26-32 in/in/° F.×10⁻⁶, a tensile strength of 0.3-3.4×10³ psi, a hardness durometer of 30 A-90 A, a hardness shore of 120-390, and a vacuum weight loss of 0.39%-0.93% after 14 days at 1×10⁻⁶ torr.

10. A method as in claim 6, wherein both ends of the hose are capable of adapting removably to a vacuum cleaning tool.

11. A wireless rubber vacuum hose, including:
a rubber middle section that includes an inner layer and a outer layer, wherein the middle section lacks a support wire and is able to withstand temperatures of at least two hundred degrees Fahrenheit; and
two ends attached to either side of the middle section, wherein at least one of the two ends is capable of adapting removably to a vacuum cleaning tool;
wherein said middle section is composed of ethylene propylene, ethylene propylene diene methylene terpolymer, or a mixture thereof suitable to withstand high negative pressure and extreme temperature; and
wherein said ethylene propylene, ethylene propylene diene methylene terpolymer, or mixture thereof has a density of 0.86 g/cm³, a maximum use temperature of 400° F., a minimum continuous use temperature of −75° F, a thermal conductivity of 0.15 btu/hr/sq.ft/°F/ft, a cubical coefficient of expansion of 26-32 in/in/°F×10⁻⁶, a tensile strength of 0.3-3.4×10³ psi, a hardness durometer of 30 A-90 A, a hardness shore of 120-390, and a vacuum weight loss of 0.39%-0.93% after 14 days at 1×10⁻⁶ torr.

12. A wireless rubber vacuum hose as in claim 11, wherein the rubber middle section is flexible enough to be tied into a knot without damage.

13. A wireless rubber vacuum hose as in claim 12 wherein both ends of said vacuum hose are capable of adapting removably to a vacuum cleaning tool for vacuuming debris.
